(19) United States
(12) Patent Application Publication
(10) Pub. No.: US 2021/0334921 A1
(43) Pub. Date: Oct. 28, 2021

(54) Career Accelerator Toolkit

(71) Applicant: George Mason Research Foundation, Inc., Fairfax, VA (US)

(72) Inventors: Marc T. Austin, Washington, DC (US); Eric Lawrence Woodall, Sterling, VA (US); Audra Meckstroth, Rockville, MD (US); David Anthony Lewis, Washington, DC (US); Peter Rea, Springfield, VA (US)

(21) Appl. No.: 17/237,427

(22) Filed: Apr. 22, 2021

Related U.S. Application Data
(60) Provisional application No. 63/013,969, filed on Apr. 22, 2020.

(51) Int. Cl. G06Q 50/20; G06Q 30/02; G06Q 10/10; G06Q 10/06; G06N 20/00; G06F 40/40

(52) U.S. Cl. CPC G06Q 50/2057; G06Q 30/0205; G06Q 10/1053; G06F 40/40; G06Q 50/2053; G06N 20/00; G06Q 10/063112

(57) ABSTRACT

Software tools serve universities and their prospective and enrolled students in the development of clearly understood career pathways, attainment of skills, and transition to employment. Exemplary embodiments are designed to better reveal the connections between chosen majors, required coursework, developed skills, future employment, and regional labor markets, while also providing data to better understand a student's process of making educational and career choices when exposed to this data. An overall goal of the product is to affect increased enrollment and successful outcomes of underserved and non-traditional students through exposure to guaranteed transfer pathways, cost savings, timely matriculation, higher retention, and increased post-graduation job opportunities focused on regional job markets.

### CROSS-REFERENCE TO RELATED APPLICATIONS

This application claims the benefit of U.S. Provisional Patent Application No. 63/013,969, filed Apr. 22, 2020, the contents of which are incorporated herein by reference.

### FIELD OF THE INVENTION

Embodiments generally relate to computer-based academic and career planning tools.

### BACKGROUND

In the current education landscape, analysis shows costly inefficiencies affecting students, institutions, and greater society. Extended matriculation time, increased costs and the consequent debt, and a failure to adequately evaluate and translate skills to the labor marketplace are widely acknowledged to waste billions of dollars annually. These issues are significant drivers in the devaluing of traditional college educations and the calls for greater scrutiny of ROI for college degrees.

Innovative responses to contemporary educational challenges are needed. Some of these challenges include: only a small percentage (11% nationally) of business leaders currently believe that college graduates are prepared for the workforce (Gallup-Lumina), significant labor gaps in key industries that require bachelor's degrees and leave hundreds of thousands of positions unfilled in the region (Burning Glass Labor Analytics), acknowledged difficulties in conveying academic achievements to the context of workplace competencies necessary to regional employers, and more.

The misalignment among student career planning choices, associate and bachelor's degree programs, skills acquisition and definition, regional workforce demands, and employer recruiting efforts results in large inefficiencies on the pathway from college enrollment to successfully establishing a career in a chosen industry.

### SUMMARY

An object of some embodiments is to address the above identified problems in the form of an online decision-making tool designed to enable course selection, career-mapping, skills development and attainment, and successful transitions from degree programs to the workforce for student populations. A title for exemplary embodiments, for ease of discussion in this disclosure, is the Advanced Career Accelerator Toolkit (ACAT). The program removes barriers and provides direct linkages from associate degrees to bachelor's degrees, among other advantages.

The ability of ACAT to focus higher education constituents on successfully approaching, addressing, and mitigating these problems will be measurable in improved outcomes and dollars saved, providing a basis for sales and licensing of the product to educational institutions. Further, built in data gathering and reporting will allow analysis of user behavior, accumulation of valuable datasets, and the expansion of ACAT's commercial potential to other markets, e.g., human resource management, job displacement management, labor market research, data brokers, etc.

ACAT benefits an array of higher education stakeholders, including but not limited to traditional student populations, non-traditional student populations, “some college, no degree” populations, career advisors, program administrators, regional employers, and higher-education researchers.

ACAT is a substantial advance in the practice of higher-education by aligning several currently disparate data sources, including syllabi, learning outcomes, associate and bachelor degree program definitions, labor analytics, and regional employer skill requirements. The solution is an integrated software tool for student higher education and career decision-making. In exemplary embodiments, ACAT comprises four complementary components; Career Pathways, Career Skills Mapping, Career Skills Tracking, and Career Skills Transparency.

The Career Pathways component is configured to present available course and degree programs to a user, in a form that: links degree pathways with quantitative labor market analytics to contextualize undergraduate degree completion in terms of the regional job market; links degree pathways to qualitative data resources to better illustrate the more intangible career experiences a degree pathway can offer, e.g., video summaries of potential career activities, flash mentoring, alumni connections, etc.; and presents high-demand skills required to fill regional employer's entry-level occupations, as identified in labor market analytics, contextualized to degree pathways.

The Career Skills Mapping component is configured to enable a student to visualize his or her expected sequence of skills attainment as they initiate a career pathway, in a form that: constructs a Skills Map presenting the student's expected milestones in skills attainment and development, categorized by e.g. institution, year, skill, and course; derives the Skills Map data from courses and timelines pre-assigned to the student's chosen Career Pathway; and provides clear, precise, and up-to-date skill definitions intended for students and employers to easily understand and share.

The Career Skills Tracking component is configured to build upon the Skills Map by presenting a similar visualization that reflects the attainment of skills during matriculation, in a form that: constructs a dynamic Skills Tracker presenting a student's actual, current milestones in skills attainment and development in a format categorized by e.g. institution, year, skill, and course; derives the Skills Tracker data from a combination of student records for completed and in-progress courses and pre-assigned course and skill data for yet to be completed skills; provides clear, precise skill definitions intended for students and employers to easily understand and share; and reflects the most up to date course and skills data, compensating for any updates that might have taken place during matriculation.

The Career Skills Transparency component is configured to prepare a student for a successful transition into the regional job market by presenting all skills attainment in a configuration very similar to an academic transcript, in a form that: constructs a Skills Transcript presenting a student's complete record of skills attainment at matriculation in a format matching the sequence of required pathway courses completed, and categorized by e.g. credits achieved, course and institution information, term, grade, and skill attained; derives the Skills Transcript data from student records and other data; and provides clear, precise, and up-to-date skill definitions, intended for students and employers to easily share and understand in the context of regional labor market.

As mentioned above, ACAT integrates four complementary components: Career Pathways, Career Skills Mapping, Career Skills Tracking, and Career Skills Transparency. This integration is achieved through the configuration of a web server, application server, databases and schemas, external data sources, and object-oriented computer programming. The implementation may include MVC design principles, i.e., separating data operations from site content. The web server provides HTTPS communications through a web interface for user display, requests, and responses. The application server (i.e., app server) is configured to store, instantiate, call, manage, and close programmed data objects, methods, and attributes. In conjunction with the database, object programming models business logic present in a transfer pipeline from community college, to 4-year undergraduate matriculation, to regional employment. Notable aspects of this model are the inclusion of labor analytics associated with specific curricular requirements, and the development, acquisition, and enumeration of skills recognized and translatable to regional employers. Specifically the model makes skills transparent to employers through any of a variety of different modalities, including micro-credentialing, filtering for skills through a career services website, and advanced block-chain approach for connecting employers to students for jobs, internships, etc.

### BRIEF DESCRIPTION OF THE DRAWINGS

FIG. 1 is an exemplary high-level architecture for ACAT.

FIGS. 2A, 2B, and 2C provide an overview of data workflow and coordination of user interfaces for an exemplary embodiment.

FIG. 3 is a flowchart for a scraping algorithm for automatic identification of skills associated with specific classes or courses.

FIG. 4 is a flowchart for establishing a taxonomy of courses that are contained within an academic pathway.

FIGS. 5A and 5B are exemplary user interfaces which may in some cases serve as a landing page for career pathway exploration.

FIG. 6 is an interface which appears upon initiation of a search using a search button.

FIG. 7 is an exemplary Career Skills Mapping component.

FIG. 8 is an interface for career pathway exploration.

FIG. 9 is an expanded career pathway data object display after selection of a specific career title.

FIG. 10A is an exemplary display of a skill roadmap section of a Career Pathways data object.

FIG. 10B is an exemplary method by which users may flag favorites and make comparisons among career pathways marked as favorites.

FIG. 10C is a roadmap visual that may be provided with the display of FIG. 10A.

FIG. 11 is an exemplary display with further labor market analytics within a Career Pathways data object.

FIG. 12 is a method which summarizes an exemplary user stimulus, system response sequence for a Career Pathways data object.

FIGS. 13, 14, and 15 show a series of exemplary displays usable for career roadmap comparison.

### DETAILED DESCRIPTION

ACAT may be referred to in this disclosure as a software tool, toolkit, system, and/or web application. ACAT allows program constituents and users (e.g., enrolled students, potential students, success coaches, career advisors, and administrators) to access and exploit an online software toolkit designed to better reveal the connections between chosen majors, required coursework, developed skills, future employment, and regional labor markets, while also providing data for administrators and researchers to analyze and better understand a student's process of making educational and career choices when exposed to this data. Data types and groupings described herein may be presented though a variety of displays which organize information in visually distinctive groupings for ease of understanding and drawing inferences. Displaying visual elements in a visually distinction manner may be achieved through physical separation of display screen space, color, shapes, or other formatting options which allow an ordinary adult to see and readily recognize a difference between one element and other elements.

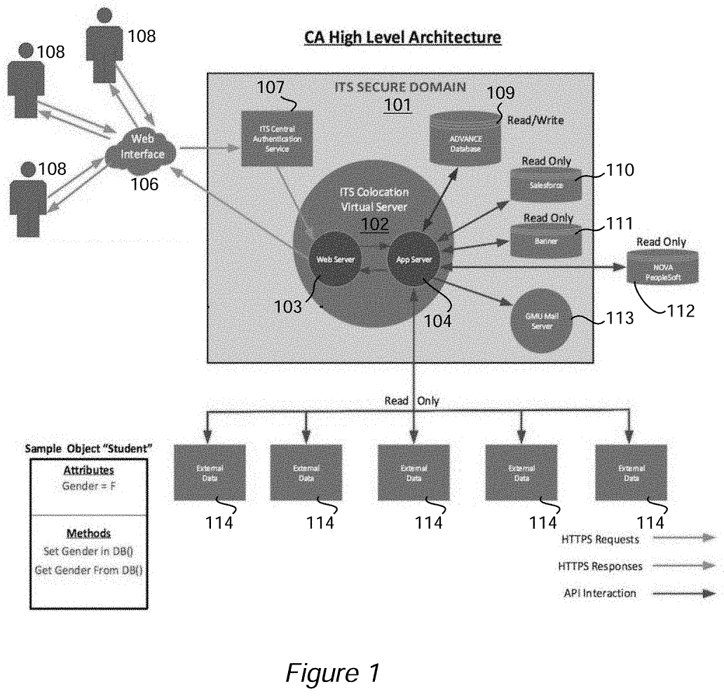

FIG. 1 depicts an exemplary high-level architecture for ACAT. In one aspect, ACAT is an Information Technology Services (ITS) collocated, virtually-served, web application. Within an ITS secure domain 101 is an ITS colocation virtual server 102 which hosts a web server 103 and an app server 104. One aspect of ACAT is a web application accessible through a web interface 106 by users 108 such as students, potential students, success coaches, and administrators to access and exploit the online toolkit. The web interface 106 receives data from web server 103. Requests from the web interface 106 may pass through an ITS central authentication service 107 before reaching web server 103 for security. Business logic and data objects are contained in the app server 104. User requests requiring data are processed here, then converted to HTML and sent to the web server 103 for delivery to the user. The app server 104 also exchanges information with a variety of databases 109, 110, 111, and 112. These databases may be within the ITS secure domain or outside of it. Some of the databases, especially external commercial databases, may have only read only access. With other databases, such as database 109, the access type may be read/write. The app server 104 may additionally exchange information with a mail server 113 and external data 114.

A “user” in this disclosure is often but not necessarily a student or prospective student. Multiple user classes exist which may receive different security templates and user landing pages. A “root” class user maintains the virtual server, database(s), frameworks, and more. A root class user is provided with super user permissions. An “administrative” (or “admin”) class user has abilities to create, approve, modify, and/or delete user entity profiles. An admin class user may be permitted to select, insert update, and/or delete data in application databases. An admin class user may be granted access and management rights to content (e.g., CMS). A “success coach” class user may be granted permissions to overview a plurality of student user and their records so as to enable collaboration with students in career planning. Student advisors such as success coaches may be able to view all components of an assigned, enrolled students ACAT functionality. “Student” class users are, as previously mentioned, the primary user envisioned throughout this disclosure. Subclasses may exist for “student” class. For example enrolled students, potential students, and non-traditional students may each be assigned a different class. All classes may have different user permissions and access compared to other different classes of users. Other permissions and capabilities may also (or alternatively) be granted beyond the exemplary listings given in this paragraph.

Exemplary software toolkits according to this disclosure have full database integration, with capabilities including but not limited to select, update, insert, and delete for data types discussed throughout this disclosure. Exemplary database design and scripting implements methods to ensure data concurrency, consistency, and integrity, such as but not limited to transaction locking, rollback, error reporting, primary and foreign keys, and more.

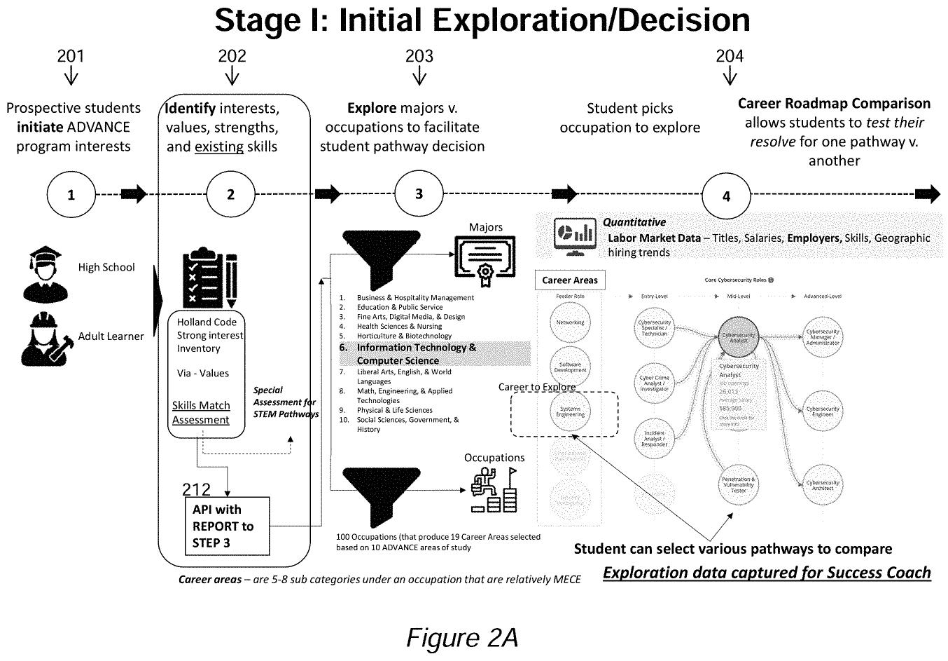

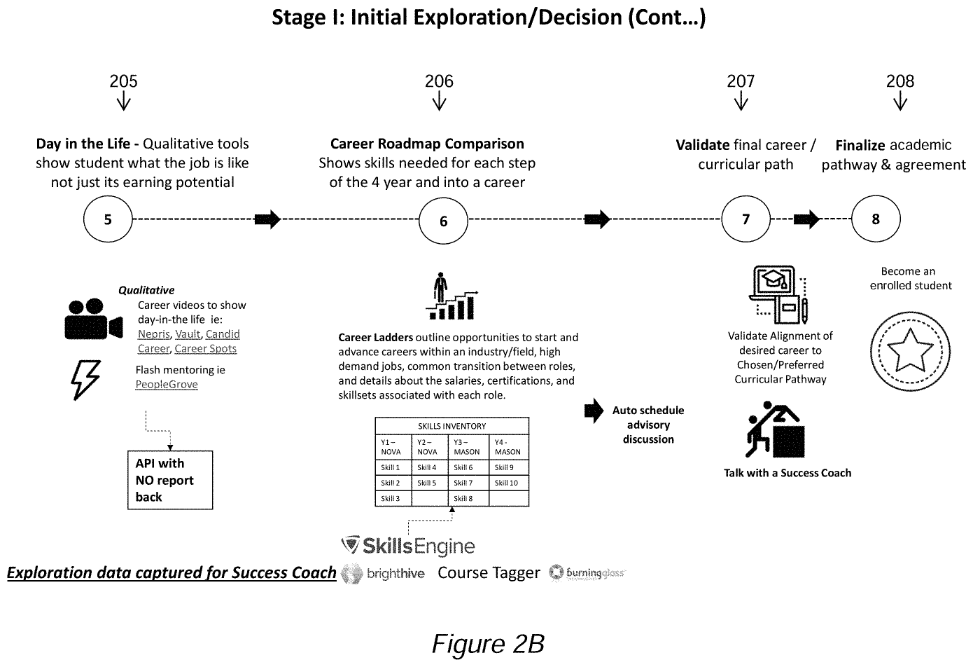

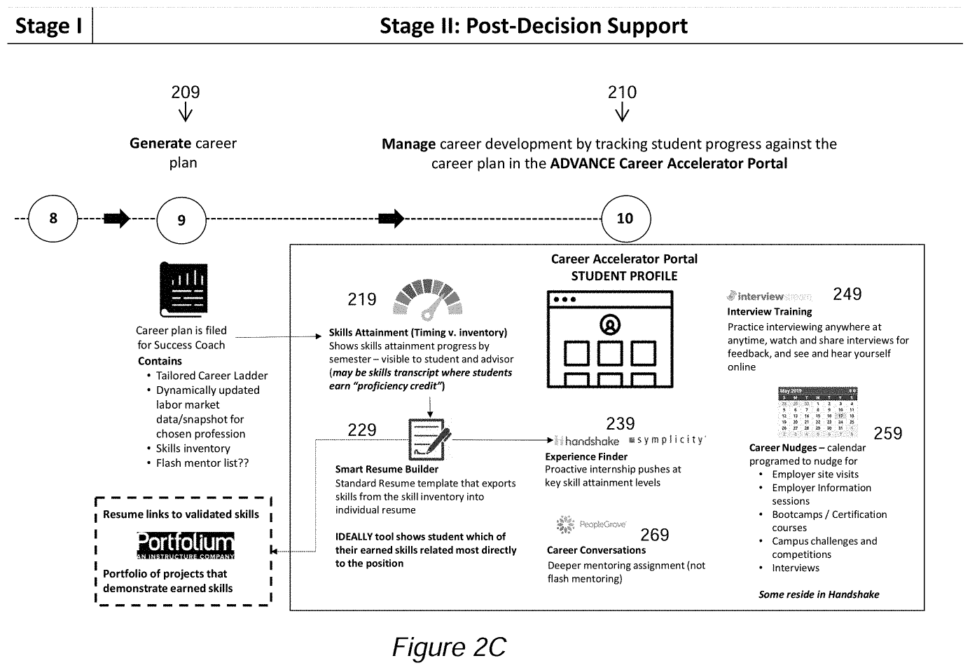

FIGS. 2A, 2B, and 2C provide an overview of data workflow and coordination of user interfaces for an exemplary embodiment. At stage 201, prospective students initiate program interests. For a given individual, a user profile may be created within the software platform. Exemplary prospective students include but are not limited to high school students and adult learners. At stage 202, the individual prospective student has engaged the platform and now must identify interests, values, strengths, and existing skills. For purposes of this disclosure, existing skills are skills a user already possesses and is able to utilize and apply. Non-existing skills are the opposite of existing skills. Non-existing skills are skills that a user does not possess and cannot utilize and apply until they are acquired. An output of stage 202 is an API 212 that reports to stage 203. At stage 203, a user is able to explore majors v. occupations to facilitate a student pathway decision. At stage 204, student are permitted to select or pick occupations to explore. A display device displays a career roadmap comparison which allows students to test their resolve for one pathway or another. Students can navigate different career path options and be provided visualizations and data pertaining to each different career path. Greater detail of exemplary career roadmap comparison interfaces are detailed below.

At stage 205, a user is provided qualitative tools to show students what a job in a selected career path is like. A benefit of stage 205 is to provide a student a more comprehensive sense of a day in the life, not simply the job's earning potential. Types of tools that may be used include flash mentoring and career videos that show day-in-the-life. As stage 206, a user is able to revisit the career roadmap comparison, this time with career ladders included. Career ladders outline opportunities to start and advance careers within an industry/field, high demand jobs, common transition between roles, and details about the salaries, certifications, and skillsets associated with each role. At stage 207, a student's final career/curricular path selected is validated. This step ensures an alignment between a selected career path and a chosen/preferred curricular pathway. A scheduling function, live chat, or video chat capability may be available in the interface to provide success coach mentoring at the validation stage or other stages. After validation is completed, the academic pathway is finalized and saved in the student records. At this stage a student may be automatically enrolled, or else flagged as enrollment ready, for one or more courses.

At stage 209, a career plan is generated. A career plan memorializes selections by the student in prior stages to provide a reference document for both the student and for success coaches and other academic advisors (e.g., counselors, mentors, professors, coaches, etc.). An exemplary career plan may contain one or more of a tailored career ladder, dynamically updated labor market data/snapshot for chosen profession, skills inventory, and a flash mentor list. Parts of a career plan or an entirety of a career plan may be generated with a commercially available input or API such as but not limited to products from Stellic® or Edunay® which are integrated with other components described in this disclosure. While in the Career Pathways component, students have the ability to view mentoring data, including opportunities to flash mentor online, e.g., PeopleGrove® online offerings.

Stage 210 is management of career development by tracking of student progress against a career plan through a dedicated online portal. The online portal is configured to permit viewing of prior selections, changes to selections, and other utilities. One exemplary widget on the career accelerator portal is a skills attainment widget 219. This widget shows skills attainment progress by semester and is generally visible to both the student and one or more advisors to the student. The skills attainment gives an idea of timing versus inventory. The skills attainment widget 219 may be a skills transcript where students earn proficiency credit. Skills may be divided into “earned” and “unearned” classifications. Skills may default to “unearned” and be switched to “earned” based on course completion and/or level of proficiency. A proficiency credit may be provided to a student record not merely for purported skill attainment but strictly for successful course completion where the course completed is pre-associated with the skill in question.

Another exemplary widget is smart resume builder 229. This widget may include a standard resume template that exports skills from the skill inventory into an individual resume. An exemplary resume links academic experience with validated skills. The widget 229 may produce a portfolio of projects that demonstrate earned skills. A commercial entity which may help support a widget 229 is Portfolium®.

A third exemplary widget is an experience finder widget 239. A proactive internship pushes at key skill attainment levels. Commercial entities which may provide the backend service for running an experience finder widget 239 are Handshake® and Symplicity®. These services may be used for both internship finding as well as job finding.

A fourth exemplary widget is career conversations widget 269. This widget gives deeper mentoring assignment than flash mentoring. A commercial entity which may provide the backend service for running a career conversation widget is PeopleGrove®.

A fifth exemplary widget is interview training widget 249. This widget allows a user to practice interviewing anywhere at any time, watch and share interviews for feedback, and see and hear oneself online. A commercial entity which may provide the backend service for running an interview training widget 249 is Interviewstream®.

A sixth exemplary widget is a career nudges widget 259. The career nudges widget 259 includes a calendar programmed to nudge a user for one or more of: employer site visits, employer information sessions, bootcamps/certification courses, campus challenges and competitions, and interviews. A commercial entity which may provide some features for the career nudges widget 259 is Handshake®.

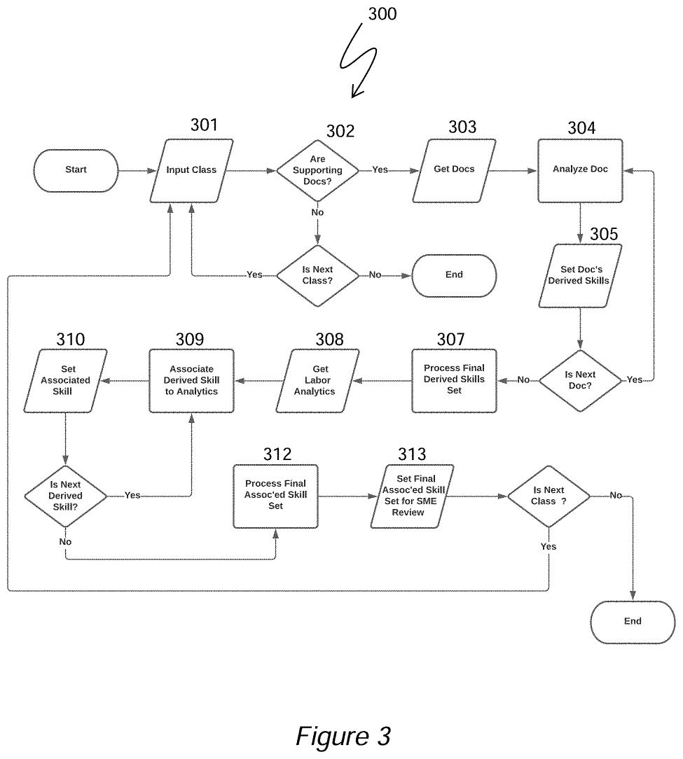

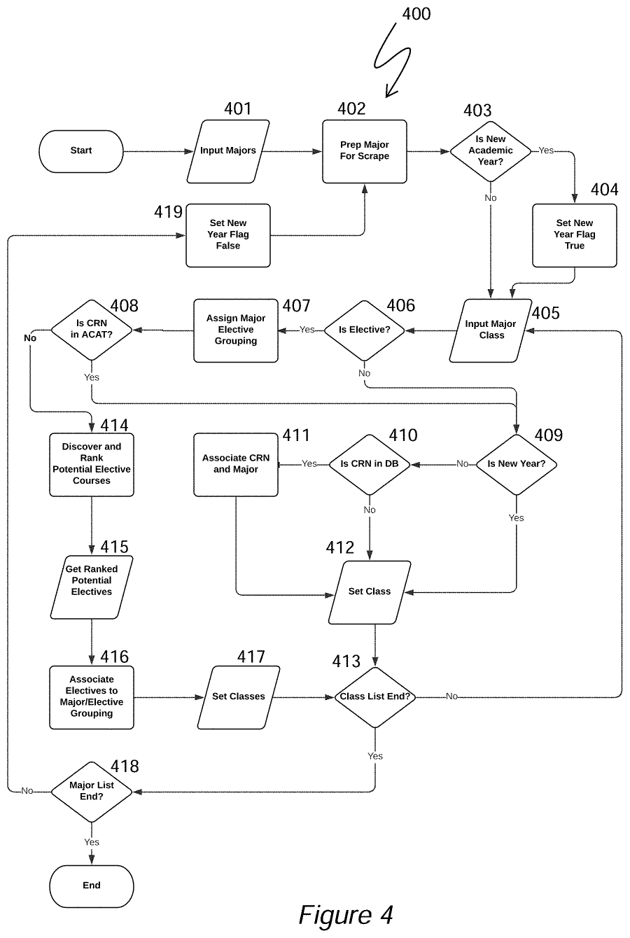

FIGS. 3 and 4 show exemplary processes for automatically processing different inputs for use in the skills-centric ecosystem of exemplary embodiments. Generally, each respective block in both flowcharts may be performed by one or more computers or servers, in particular one or more processors thereof. FIG. 1 shows an outline of exemplary networked hardware suitable for performing the processes.

FIG. 3 is a flowchart for a scraping algorithm 300 for automatic identification of skills associated with specific classes or courses. At block 301 a class is input to the processor (which may be one or more processors, but for ease of discussion the singular tense will be employed). Block 302 queries whether the class has any supporting documents, such as a syllabus, synopsis, course catalog description, or other documentation. Course names alone are not treated as conveying any discernable skills, as that term is defined in this disclosure. Therefore, if no supporting documents are identifiable at block 302, the method immediately moves on to the next class to be processed, if any such exist. Note that a course name may be identical to a skill name, but the scraping algorithm ascertains that the course in question teaches that skill not from its title, but rather from the documentation which describes the substance of the curriculum.

Any supporting documents which do exist are retrieved at block 303, ingested by the processor(s), and analyzed at block 304. The analysis of block 304 may comprise or consist of deriving skills from one or more course supporting documents by comparing terms in the course supporting documents to a library of terms, where the library of terms may be pre-populated with professionally derived skills. “Term” as used here may be a word or multiple words having special significance in combination (e.g., an expression). The analysis at block 304 may also or alternatively entail natural language processing and/or machine learning algorithms.

The output of the analysis of block 304 is derived skills. “Derived skills” are those which have been discovered from the analysis (e.g., Natural Language Processing, Machine Learning, etc.) of a course's supporting documents (e.g., syllabi, course descriptions, etc.) in the context of labor market analytics and probabilistic career paths related a student's chosen major. In some cases, a “derived skill” may be either a skill derived from a support document for one or more courses or else a skill derived from labor market data. These two forms may be referred simply as academically derived skills and professionally derived skills, for example.

A supporting document's derived skills are set at block 305. Analysis for derived skills is repeated for all documents that are associated or affiliated with the specific class in question. (As used in this disclosure, “course” and “class” may be used interchangeably.) As supporting docs are analyzed in blocks 304-305, a preliminary list of derived skills is built. After all supporting documents for the class have been analyzed, a final derived skills set is processed at block 307. The derived skills data set is filtered to remove duplicate skill listings and other potential undesirable elements.

Labor analytics are retrieved at block 308. Derived skills from block 305 and labor analytics from block 308 are then associated with one another at block 309. Associated skills are set at block 310. The association of block 309 and setting of block 310 is repeated for all of the derived skills from block 305. After the derived skills list is finalized, it is processed to associate selected skills to courses. The processing includes taking a discovered derived skill and comparing it to a data set of other skills within the probable career path(s) of a student. The comparison is measured through a filter of attributes such as labor market demand for the skill, geographical scope (e.g., local, regional, national), and/or other attributes. If the skills “ranking” meets the selection criteria of the application administrators, the course is associated with the skill by combining a unique identifier for both the skill and course. The association (the unique identifier(s)) is recorded within ACAT's one or more databases if the selection criteria is not met. If selection criteria are not met, an association is not made. Respective users are also assigned unique identifiers. The system may match the unique identifier of a student with a unique identifier of a course to derive an acquired skill for that student with respect to the course.

At block 312, the final associated skill set are processed. The processing at block 312 may comprise identifying and resolving any error-handling, inserting and/or updating skill associations, resolving any data issues (e.g., datatypes, amount of data quantity, etc.) for database table(s), prepping data for use in SMEs skills validation app, and other uses.

At block 313, a final associated skill set is set for subject matter expert (SME) review. Exemplary SME review may comprise the following: using a web-based dashboard, the SME is presented with all courses and all skills respectively associated with those courses. Prior to the SME's review, the process may involve a sorting or filtering algorithm to determine which courses are most skill rich or most enrolled in order to prioritize those courses that are likely to have the biggest impact on a student's skills roadmap/transcript. SME's then validate (e.g., by entering a validation field value of true or false, for example) that a respective skill aligns with a respective course and provides a level of proficiency typically denoted by e.g., blooms taxonomy. SME review is generally configured to focus on the courses with the greatest impact on student skills as a method of minimizing SME time on the task of validating skills.

The method 300 is repeated for each class available which has not yet been processed for skills. Results of an algorithm such as algorithm 300 may be presented to any type of user, e.g. a student or an administrator. For instance, an administrator may be provided the option to review all student skills available at a university and provide students with one or more of (1) a list of skills each student has acquired by class, (2) a view of which skills each student may be missing for jobs the respective student is interested in as she or he makes his or her way through their degree, and (3) a recommendation of courses to take to fill key skill gaps for desired employment outcomes the respective student may seek. Results may be output to employers, permitting them to review the skills attained by students so the employers can directly approach and recruit those students for jobs requiring those unique mix of skills desired by the employers. This in effect has the ability to eliminate the necessity of both a Resume and a Job Description, neither of which work well for employer or worker.

FIG. 4 is a flowchart for an exemplary algorithm 400 for establishing a taxonomy of courses that are contained within an academic pathway (i.e., a bachelor's degree or college major) and other similar courses of study. The courses of study ACAT impacts are regularly composed of explicitly enumerated courses in combination with elective choices. Courses may also change year over year by student cohort or class. Students acquire elective course credit by choosing from constrained lists of multiple courses, often governed by separate jurisdictions within the institution and unknown until a student registers and completes a course. ACAT effectively and consistently bridges the gap between labor markets, academic programs, and courses through a “language” of skills repeated as students matriculate. Building this language requires a taxonomy to pragmatically scope the domain of the many potential electives' many defined skills. To aid with student engagement in career-planning and post-matriculation successes, ACAT uses the taxonomy to identify predictive patterns of elective choices and the derived skills electives' derived skills to better inform students of the wide range of their choices' impacts, and to increase efficiency in SME review of courses and skills.

In FIG. 4, at block 401 majors are input. At block 402 a major is prepped for scraping. Block 403 queries whether it is a new academic year. If yes, a new year flag is set to true at block 404. At block 405, major class is input. Block 406 queries whether the class from block 405 is an elective. If the class is an elective, a major elective grouping is assigned at block 407. Block 408 queries whether the course reference number (CRN) is in ACAT. If the CRN is already in ACAT, block 409 queries whether it is a new year. If not, block 410 queries whether the CRN is in the database (DB). If yes, the CRN is associated with the major. At block 412, the class is set. If the answer to the query at block 408 was no, then at block 414 potential elective courses are discovered and ranked. At block 415, potential electives are ranked. At block 416, electives are associated to major/elective grouping. At block 417, classes are set. Block 418 causes the algorithm 400 to generally repeat for each major in the academic year. Block 413 causes the algorithm 400 to generally repeats for each class until all classes for a given major are processed.

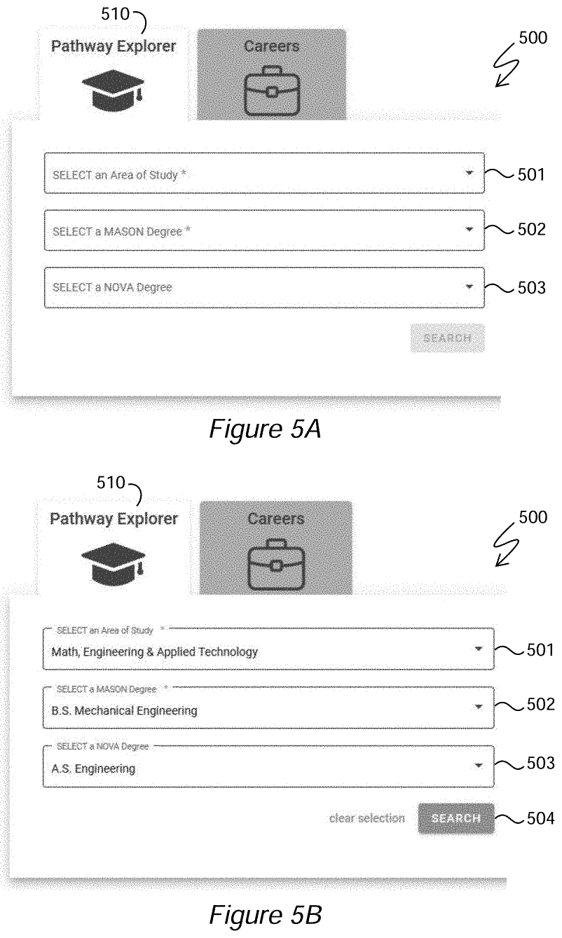

FIG. 5A is an exemplary user interface 500 which may in some cases serve as a landing page for career pathway exploration (stage 203 in FIG. 2A). The interface 500 is available under a menu tab 510 for pathway explorer. In this example, the interface 500 serves multiple career advancement inquiries. One or more fields 501, 502, and 503 respectively permit selection by a user of an area of study, a degree from a first academic institution, and a degree from a second academic institution. “Area of study” in this disclosure may be defined as a curated grouping of associated degree programs. Each field 501, 502, and 503 may have a respective dropdown menu populated with a particular institution's options available to students of that institution. The separate dropdown menus 502 and 503, both for degrees, may provide separate menus for four year degrees versus two year degrees, for example. In this way the tool allows for career mapping not just from a four year program to the workforce but from two year programs to the workforce as well. The interface 500 may allow for exploration and comparison not just of different career paths, but of different academic paths within the same institution as well as among different institutions which can lead to the same or different careers.

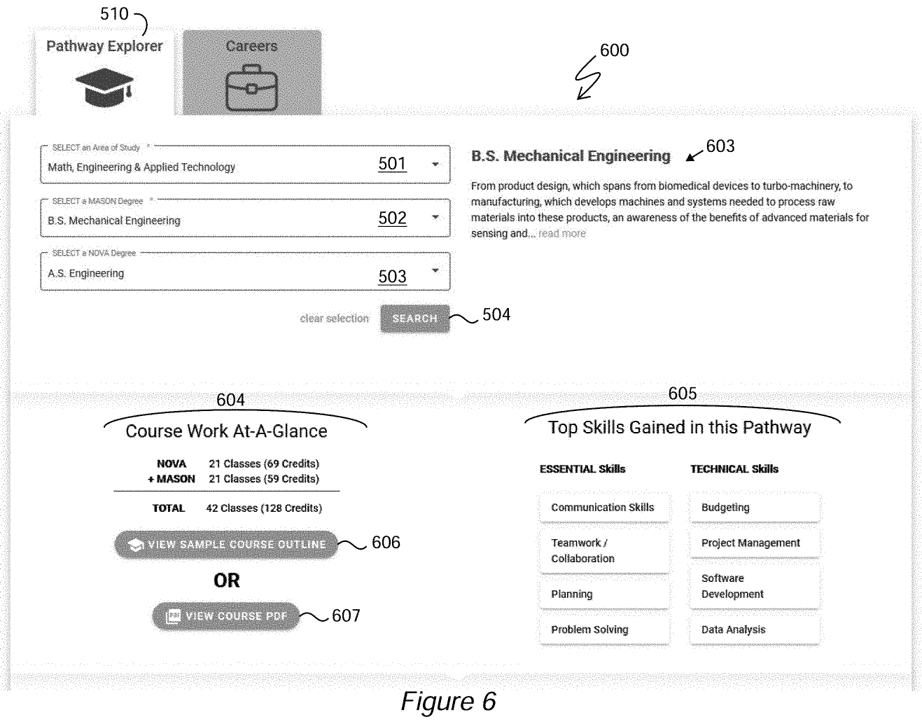

FIG. 5B shows interface 500 with selections entered in the three fields 501, 502, and 503. A user selecting the search button 504 opens new display features shown in FIG. 6.

FIG. 6 is an interface 600 which appears upon initiation of a search using search button 504. The interface 500 is a part (but less than a whole) of interface 600. A description 603 provides a synopsis of the degree (or degrees) selected in fields 502 and 503. Below in the display 600 are two distinct visuals providing insight into the degree selection in field 502. Visual 604 provides the user with a course work at-a-glance overview. The visual 604 reflects a number of classes and a number of credits required to complete the selected degree. In addition, it includes two buttons 606 and 607 to navigate to or open additional information. Button 606 permits a user to view a sample course outline. Button 607 permits a user to view a course pdf.

The visual 605 provides a user a first look at skills associated with the area of study and degree(s) selected in fields 501, 502, and 503. The visual 605 is organized into categories of skills, in particular essential skills versus technical skills. “Essential” skills (also referred to as soft skills) are critical interpersonal communication, thinking and teamwork, commonly associated with personal and team management. An example is “making presentations.” Technical skills relate to specific tasks, often times requiring the use of technology that require specific v. general training. An example is “coding in python” computer language. Essential skills may include but are not limited to communication skills, teamwork/collaboration, planning, and problem solving. Technical skills may include but are not limited to budgeting, project management, software development, and data analysis.

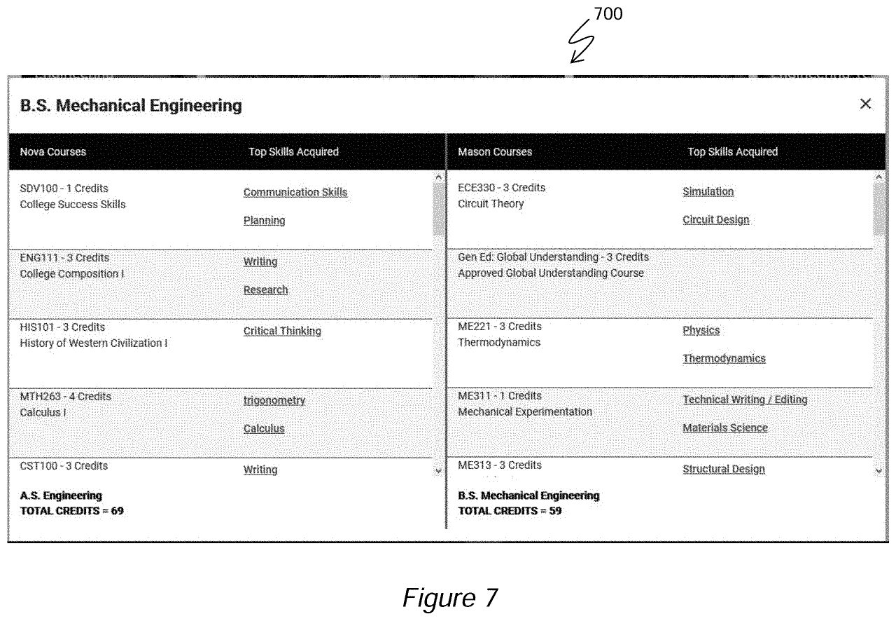

FIG. 7 exemplifies a Career Skills Mapping component of exemplary embodiments. FIG. 7 shows a popup window 700 that appears when a user clicks the button 606 (FIG. 6) to view a sample course outline. The display 700 organizes sample courses into columns with corresponding top skills associated with each course. For example, a course titled “Circuit Theory” corresponds with top skills simulation and circuit design. An exemplary Career Skills Mapping component is configured to allow a student to view a “Skills Map” that visualizes the expected sequence of skills attainment assigned to their chosen pathway, and aligned to the expected sequence of classes to be completed each semester for a specific pathway. The skills map may contain course, general and specific skill, and skill definition information. An exemplary skills map experience may be as follows. A user (e.g., student) accesses a skills map from a career skills landing page. The system displays a view of the map and receives a selection from the user of a skill from the map. The system displays the skills name and definition and courses aligned with the selected skill. The system displays options to copy the skill and course(s) to clipboard. The student may then exit the skills map view.

In exemplary embodiments, a Career Skills Mapping data object contains methods and attributes to create a shareable initial timetable and curricular path for skills attainment, developed from the parameters of required courses in a chosen career pathway, and derived from the skills engine. This mapping will be created for enrolled students who have chosen their Career Pathway.

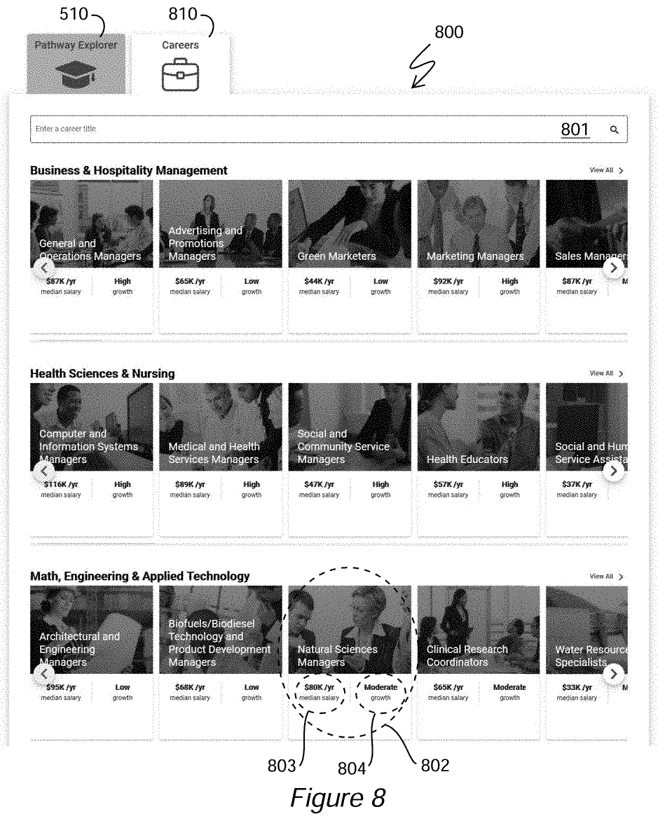

FIG. 8 shows a display 800 under a tab 810 which is an alternative tab to tab 510 for pathway explorer. The tab 810 opens a display of career pathways data objects. An exemplary Career Pathways data object contains methods and attributes to search, select, associate, link, and display career pathways database content with up-to-date regional and national labor analytics data. The user interface and object methods will create and offer multiple starting points to search for career pathway data derived from internal and external data sources. For example, a search may start with a college major (as in interface 500 of FIG. 5A) or, instead, with a representative job title from the regional labor market. The interface 800 allows for searches within or among curated occupational groupings (e.g., curated groupings of associated job titles), with results displaying representative labor analytics as well as associated degree pathways that will lead to the searched job titles. For example, a job title is insertable in field 801 in interface 800 of FIG. 8. Both search paths expose relevant academic and labor data, linking original search selections with statistically associated career outcomes and/or academic programs, enabling more informed career choices and more efficient higher education operations. This component may be made available to authenticated and anonymous users. For instance, enrolled students as well as potential students may have the same level of access to a majority of functionalities in the academic and career pathway explorer tools.

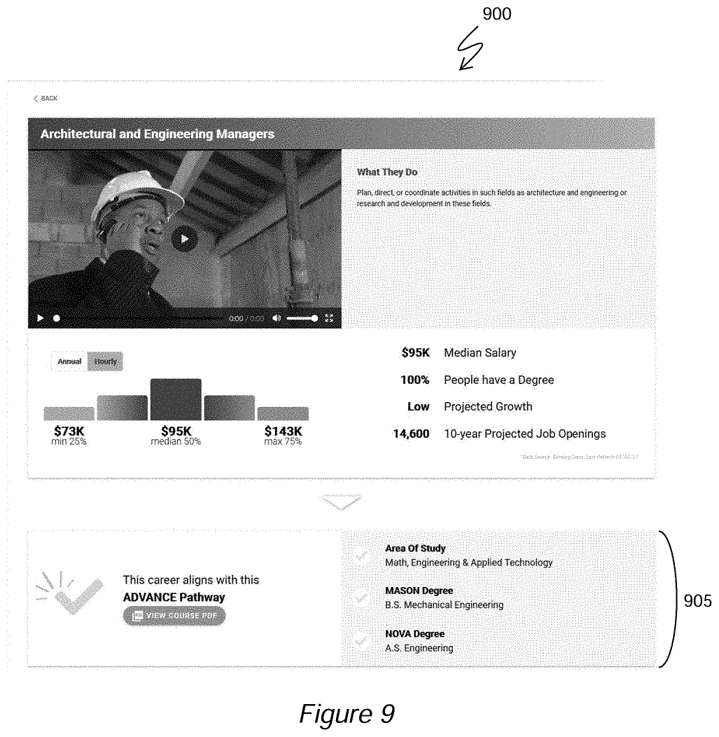

FIG. 8 shows three rows of career pathway objects, organized according to disciplines. In interface 800, each object 802 contains one or more of a job title, illustrative picture from professional in the indicated line of work, median salary 803, and present growth rate 804 in that particular field. Additional, fewer, or alternative data analytics may be provided through interface 800 and/or through display 900 (FIG. 9, discussed below). A non-limiting list of data analytics includes median salaries, regional job demand, top employers, required skills, and preferred skills. The Career Pathways component of the toolkit engages students in a high dynamic review of the degree pathways (i.e., majors) and the pathways' interconnections with gathered and curated career outcomes. Users are supplied the ability to navigate and select degree pathways and then to view them in the context of related occupational groupings (e.g., Business & Hospitality Management; Health Sciences & Nursing; Math, Engineering & Applied Technology as three examples in FIG. 8), representative job titles, and labor analytics.

FIG. 9 shows an expanded career pathway data object display 900 after a user selects one career pathway among the options in display 800 of FIG. 8. While in the Career Pathways component, students have the ability to view data, including video, showing the qualitive aspects of future jobs and majors. Display 900 includes the information for the one career pathway selected that was available in display 800 and adds additional information. Information that may be displayed to a user may include but is not limited to annual or hourly salary distribution, median salary, percentage of the profession having a degree, projected growth in that career's job market sector, and 10-year projected job openings. The display 900 may also include descriptions of the occupation, including but not limited to written summaries and illustrative videos. Significantly, display 900 includes a section 905 which clearly indicates whether an academic pathway previously selected (e.g., in menu 500 of FIG. 5A) and the displayed career align with one another.

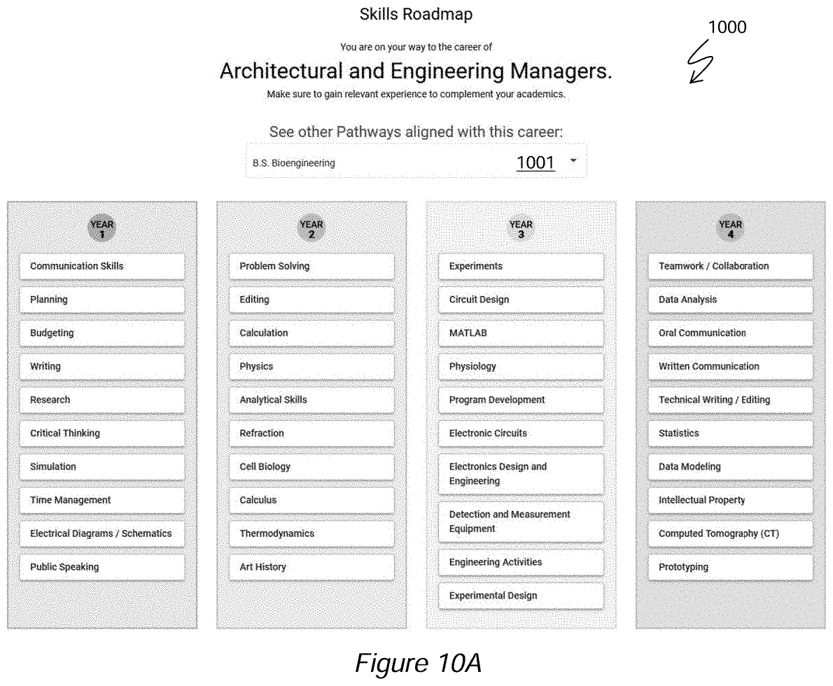

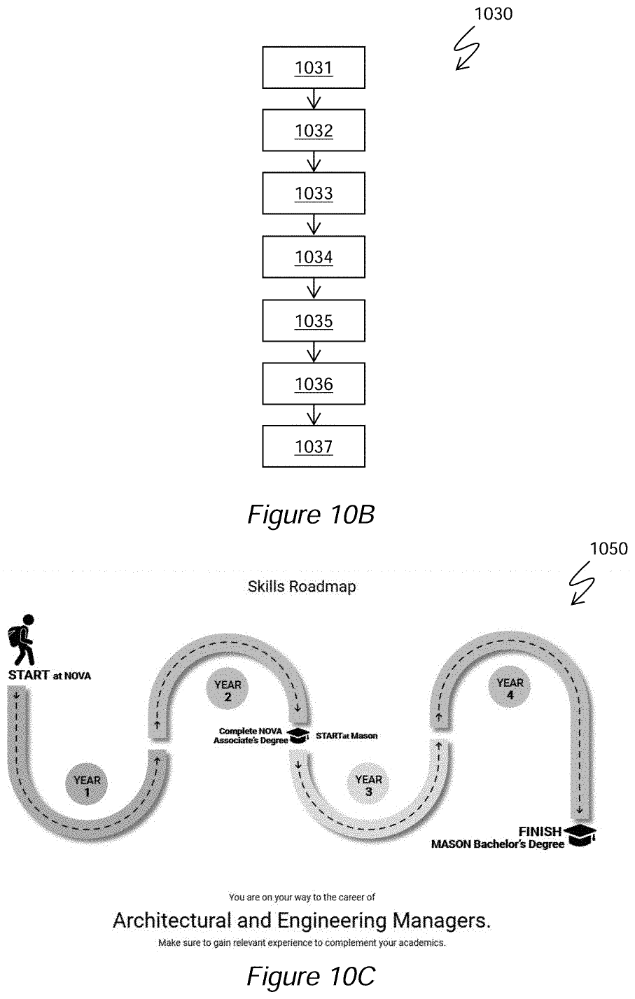

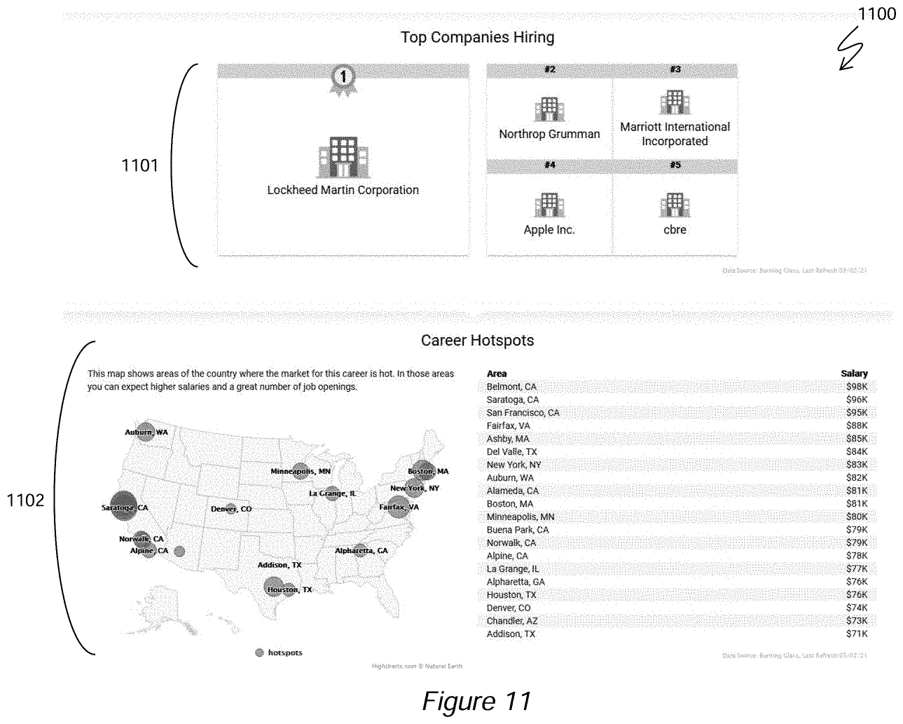

FIG. 10A shows an exemplary display 1000 of a skill roadmap section of a Career Pathways data object. In the example of FIG. 10A, four years of coursework is divided into four columns, one for each year. Within each column the student's to-be-acquired skills (based on coursework to be completed) are automatically populated. The skills are organized according to a particular career pathway selection. In this illustrated case, the particular career pathway selected is Architectural and Engineering Managers. Though a student may of course take some courses that offer skills beyond those associated with the selected career, non-associated skills are not displayed until a different career pathway is selected in a dropdown menu of filed 1001. The Skills Roadmap allows for comparison of actual skills attainment to the Career Skills Mapping of alternate career pathways, and, also, to compare current skills attainment to potential career outcomes in the context of labor market analytics. As students explore possible degree pathways and occupational groupings, they are provided a process to flag some items as favorites, and later to compare selected labor analytics and skills attributes of two or more favorites in order to refine their career pathway choices.

FIG. 10B shows an exemplary method by which users (e.g., students) may flag favorites and make comparisons among career pathways marked as favorites. At block 1031, a user is authenticated or granted guest access in a Career Pathways component. At block 1032, a user is displayed job title information at the culmination of a Career Pathway search. At block 1033, a user selects favoriting icon for a selected job title, and the system receives the user selection. At block 1034, a user selects to compare favorites if more than one favorite exists, and the system receives the user selection. At block 1035, a user is displayed a list of favorites and provided the ability to select a predetermined number to compare. At block 1036, a user selects job titles to compare, and the system receives the user selection. At block 1037, the system displays the comparison (e.g., in a column format) with options to save, print, and/or export.

FIG. 10C provides a roadmap visual 1050 that may be provided with the display 1000 of FIG. 10A. The roadmap visual 1050 provides a visual sequentiality to the skills listed in the columns of display 1000.

FIG. 11 shows an exemplary display 1100 with further labor market analytics within a Career Pathways data object. Section 1101 shows top companies hiring in a particular field, and section 1102 shows a geographic map of career hotspots together with a table reflecting average salaries for the selected career field in a plurality of different cities.

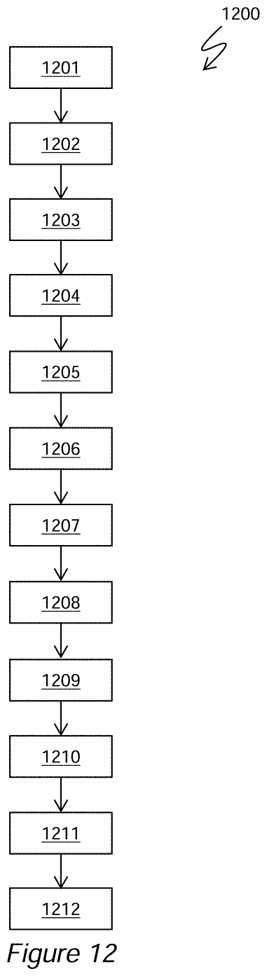

FIG. 12 depicts a method 1200 which summarizes an exemplary user stimulus, system response sequence for a Career Pathways data object. Generally, the steps of method 1200 correspond with the descriptions above for the interfaces depicted by FIGS. 8-11. At block 1201, from prospective student/enrolled student (PS/ES) landing pages, the system receives a user selection of a Career Pathways component. At block 1202, a user chooses to search the component by “Area of Study” (majors) or “Occupational Grouping” (jobs), and the system receives the user choice. At block 1203, depending on choice, a user selects a single Area of Study from a list of all Areas retrieved from the database, or a single Occupational Grouping from a list of all Groupings retrieved from the database, and the system receives the user selection. At block 1204, the system displays for the user's viewing all majors retrieved from the database that are associated with a selected Area of Study, or all job titles retrieved from the database that are associated with an Occupational Grouping. At block 1205, the system receives a user selection of a single major from the list of majors, or a single job from the list of job titles. At block 1206, a user selection of a single job from a list of job titles completes the search by Occupational Grouping option. At block 1207, continuing with search by Area of Study, the system displays for a user to view Occupational Groupings retrieved from the database that are assigned to the selected major. At block 1208, a user selects a single Occupational Grouping from the list of Occupational Groupings, and the system receives the user selection. At block 1209, the system displays for a user to view Job Titles retrieved from the database that are associated with the selected Occupational Grouping. At block 1210, a user selects a single Job Title from the list of Job Titles, and the system receives the user selection. At block 1211, the Search by Area of Study is complete. At block 1212, a completion of search processes reveals labor analytics and skills data related to the Job Title.

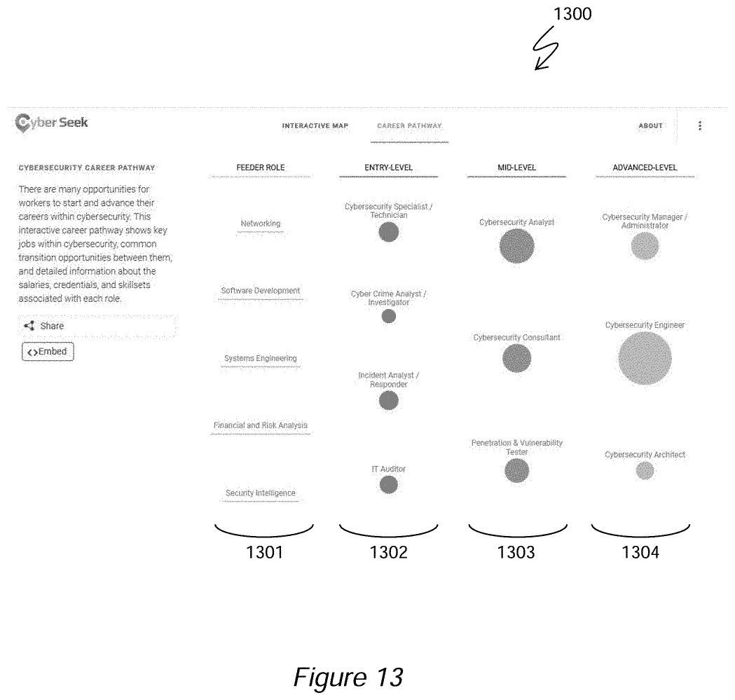

FIGS. 13-15 show a series of exemplary displays usable for career roadmap comparison 204 of FIG. 2A. For illustrative purposes, the interface 1300 is populated with data for cybersecurity career tracks. Job groupings and job titles are organized into a plurality of columns 1301, 1302, 1303, and 1304. Column 1301 contains a list of feeder roles. In this example, the feeder roles are networking, software development, systems engineering, financial and risk analysis, and security intelligence. Specific job titles/positions which stem from or fall under the feeder roles are organized into a plurality of columns based on experience level. In this example, the jobs are organized into three columns: entry-level, mid-level, and advanced-level. Entry-level positions are arranged in column 1302. Mid-level positions are arranged in column 1303. Advanced-level positions are arranged in column 1304. Any of the feeder roles or job positions may be selected by a user, e.g. by a user hovering over or clicking on the name.

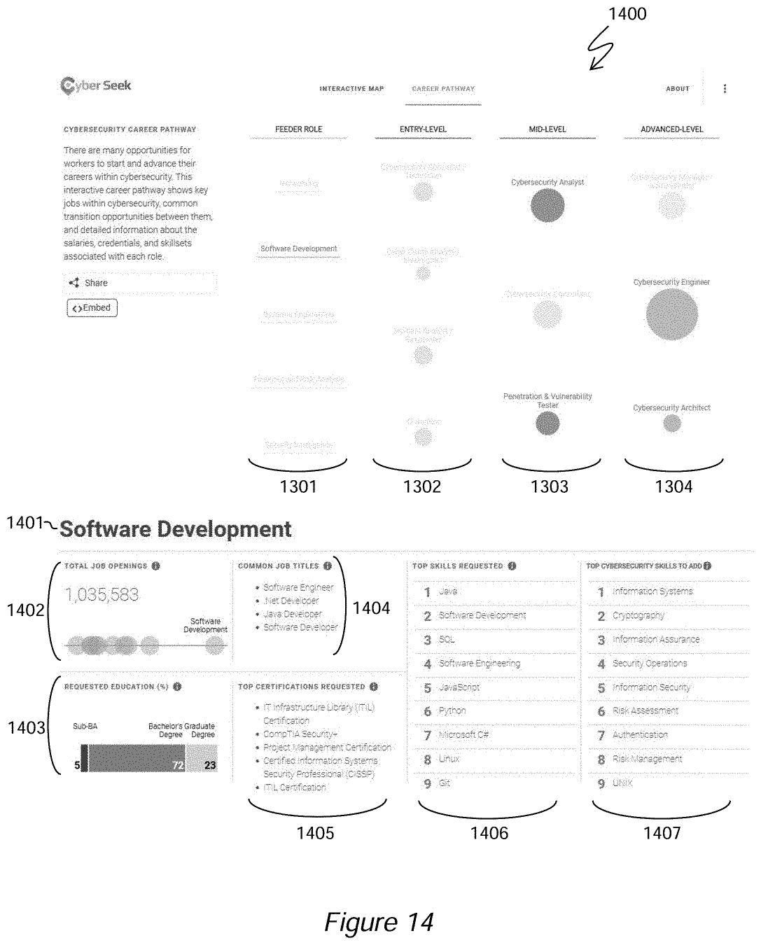

FIG. 14 shows interface 1400 which is a transformation of interface 1300 after a user has clicked a feeder role in column 1301. In this example, the selected feeder role is Software Development, which is displayed prominently in a title bar 1401. The column 1301 changes the opacity or implements another visible alteration which highlights the selection of software development and non-selection of the alternative options in column 1301. Similarly, a visual alteration is effected throughout the other columns 1302, 1303, and 1304 to reflect job positions which do and those which do not stem from the selected feeder role. In this example, none of the entry-level positions stem from the feeder role of Software Development, and therefore the entire column 1302 is displayed with a reduced opacity, e.g. 50% reduced opacity. In columns 1303 and 1304, positions that stem from the selected feeder role are shown with 100% opacity, whereas positions that do not stem from the selected feeder role are shown with <100% opacity.

In addition to the visual changes in columns 1301, 1302, 1303, and 1304, several career analytics are displayed for a user's visual consumption. Display block 1402 indicates the total job openings for the selected feeder role. Display block 1403 displays the requested education (by percentage) from employers. Display block 1404 lists common job titles under the feeder role. Display block 1405 lists top certifications requested. Display block 1406 lists top skills requested. Display block 1407 lists top (cybersecurity) skills to add.

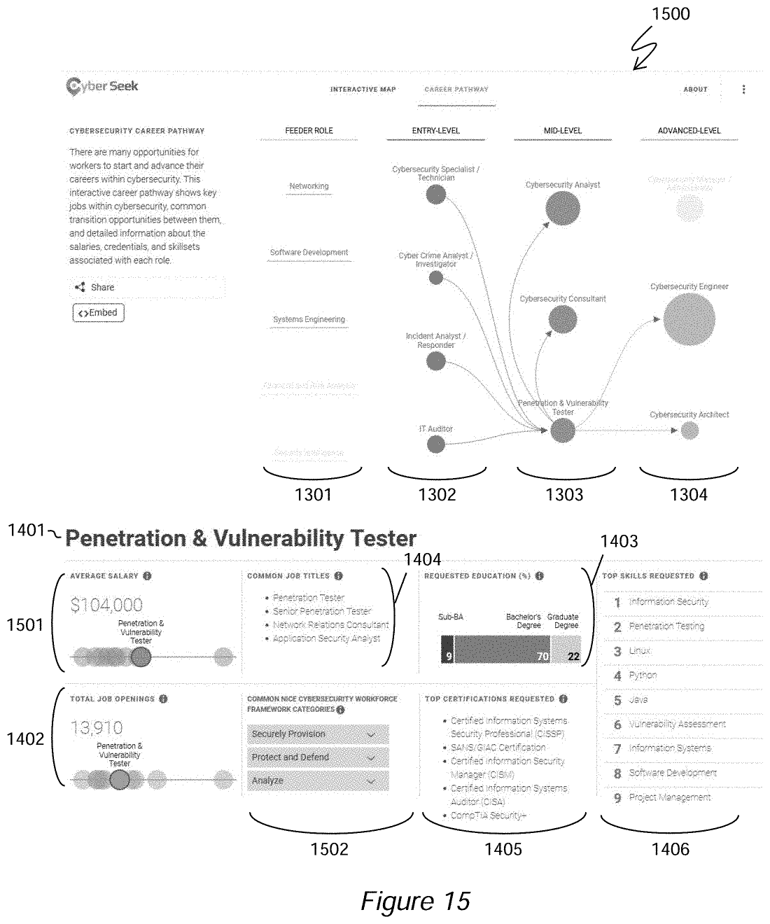

FIG. 15 shows an interface 1500 which is a transformation of interface 1300 after a user has clicked a job position in any of columns 1302, 1303, and 1304. In this example, the option for Penetration and Vulnerability Tester has been selected, as indicated by title bar 1401. Visual cues like opacity have again been used to show options in each of the columns which are, and which are not, associated with the selected option. Furthermore, arrows are displayed which give a user a visual understanding of career tracks. In particular, arrows indicate lower level jobs which may be useful in a career track leading to the selected job. Further arrows indicate equal level or higher level jobs which may be attainable after experience is gained in the selected option. Information fields are again displayed to show useful career analytics for the selected option. Fields 1402, 1403, 1404, 1405, and 1406 are as in FIG. 14, except with updated content to reflect the updated user selection from columns 1301, 1302, 1303, and 1304. In addition, two other data fields are shown. Display block 1501 shows average salary. Display block 1502 shows common (nice cybersecurity) workforce framework categories. Additional and/or alternative data fields and blocks may be shown in various embodiments.

An exemplary Career Skills Tracking data object contains methods and attributes to create an up to date record of actual skills attainment, based on a student's completed coursework, and in comparison to the planned skills attainment created in the initial Career Skills Mapping. The Career Skills Tracker provides visualization of the actual skills attained during a student's matriculation. The Skills Tracker object reflects any planned or unplanned deviation from the pathway chosen at a student's initial enrollment with the program by checking actual course completion data. The Skills Tracker, like the Skills map, provides skill and course information to the user, and account for any updates or changes in pathways that may occur during matriculation.

An exemplary Career Skills Transparency data object contains methods and attributes to create a skills transcript for matriculating students who seeking employment in occupations associated with their chosen career pathway. The skills transcript may contain a listing of classes and skills, with reminders of what was done to attain each skill listed. Listed courses may be paired with associated derived skills to show their association with one another. This data object constructs a Skills Transcript presenting a student's complete record of skills attainment matching the sequence of required pathway courses completed, and categorized by credits achieved, course and institution information, term, grade, and skill attained. The skills transcript presents a listing of actual skills attained during coursework in a format designed to convey relevant, clear, understandable, standardized, and in-demand labor market skills in a language germane to potential regional employers. Further, the Career Skills Transparency component will be designed to anticipate future inclusion in automated resume creation and employment-listing platforms.

In its essence, the Career Skills Transparency components provides a “skills transcript” and a “skills language” for students and employers. Within the model, this transcript will be constructed through a “skills engine,” comprised of programming, data-objects, and database schema interactions that are regularly informed by labor market analytics and regional employer exchanges. The creation of this skills transcript, conveyed in a common skills language, and derived from a database skills engine, will contextualize warranted associations between regional labor market demands and academic programs.

Some embodiments of the present invention may be a system, a device, a method, and/or a computer program product. A system, device, or computer program product may include a computer readable storage medium (or media) having computer readable program instructions thereon for causing a processor to carry out aspects of the present invention, e.g., processes or parts of processes or a combination of processes described herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Processes described herein, or steps thereof, may be embodied in computer readable program instructions which may be paired with or downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions and in various combinations other than those illustrated.

These computer readable program instructions may be provided to one or more processors of one or more general purpose computers, special purpose computers, or other programmable data processing apparatuses to produce a machine or system, such that the instructions, which execute via the processor(s) of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

User inputs in this disclosure may be entered through any of a variety of user devices such as but not limited to touchscreens, laptops, smartphones, keyboards, buttons, and mice. Outputs to users are often but not always necessarily visual as through touchscreens, smartphones, displays, projectors, head mounted displays (HMDs), screens, and the like. Outputs may take other forms such as auditory output through speakers.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be separated from or combined with the features of any of the other several embodiments without departing from the scope or spirit of the present invention. Any recited method can be carried out in the order of events recited or in any other order which is logically possible.

While the invention has been described herein in connection with exemplary embodiments and features, one skilled in the art will recognize that the invention is not limited by the disclosure and that various changes and modifications may be made without departing from the scope of the invention as defined by the appended claims.

What is claimed is:

1. A computer-implemented method for academic and career advancement support, comprising
deriving skills from one or more course supporting documents;
ranking derived skills by level of demand and/or geographical scope in labor market data; and
outputting the ranking for viewing by one or more users.

2. The computer-implemented method of claim 1, wherein the step of deriving skills comprises comparing terms in the course supporting documents to a library of terms.

3. The computer-implemented method of claim 1, wherein the step of deriving skills comprises one or more of natural language processing and machine learning.

4. The computer-implemented method of claim 1, further comprising
associating with a unique identifier in records of one or more databases respective derived skills and respective courses within one or more career paths available to students.

5. The computer-implemented method of claim 1, wherein the supporting documents comprise course descriptions and one or more course syllabi.

6. The computer-implemented method of claim 1, further comprising
validating the derived skills prior to ranking; and
eliminating any derived skills from the output step which fail validation.

7. The computer-implemented method of claim 6, wherein the validation comprises subject matter expert (SME) review.

8. The computer-implemented method of claim 1, further comprising
separating the derived skills into a first grouping and a second grouping, the first grouping for skills derived from courses a specific student has completed, the second grouping for skills derived from courses the specific student has not completed,
wherein the outputting step comprises displaying the first grouping and second grouping visually distinctive from one another.

9. The computer-implemented method of claim 1, further comprising
receiving a selection of a specific occupation or career title from a listing of career titles,
wherein the ranking and outputting steps are limited to derived skills associated with the selected specific career title.

10. The computer-implemented method of claim 9, further comprising
automatically generating for display a course listing of available courses associated with the second grouping.

11. The computer-implemented method of claim 1, further comprising
wherein the labor market data is limited to a specific selection of labor markets.

12. The computer-implemented method of claim 11, further comprising
identifying employers actively hiring for positions requiring one or more of the derived skills.

13. The computer-implemented method of claim 1, wherein the outputting step comprises automatically generating a skills transcript that shows courses paired with associated derived skills.

14. The computer-implemented method of claim 1, wherein the outputting step comprises displaying
a list of skills each student of a plurality of students has acquired by class,
a view of which skills each student is missing for one or more pre-selected jobs, and
a recommendation of courses for enrollment to fill skill gaps for the one or more pre-selected jobs.

15. The computer-implemented method of claim 14, wherein the outputting step further comprises automatically generating a skills transcript for each student that shows courses paired with associated derived skills.

16. A system for academic and career advancement support, comprising
one or more processors configured to execute computer readable program instructions which, when executed, cause the one or more processors to perform:
deriving skills from one or more course supporting documents;
ranking derived skills by level of demand and/or geographical scope in labor market data; and
outputting the ranking for viewing by one or more users.

17. The system of claim 16, further comprising
associating with a unique identifier in records of one or more databases respective derived skills and respective courses within one or more career paths available to students.

18. The system of claim 16, further comprising
separating the derived skills into a first grouping and a second grouping, the first grouping for skills derived from courses a specific student has completed, the second grouping for skills derived from courses the specific student has not completed,
wherein the outputting step comprises displaying the first grouping and second grouping visually distinctive from one another.

19. The system of claim 16, further comprising
receiving a selection of a specific career title from a listing of career titles,
wherein the ranking and outputting steps are limited to derived skills associated with the selected specific career title.

20. The system of claim 16, wherein the outputting step comprises displaying
a list of skills each student of a plurality of students has acquired by class,
a view of which skills each student is missing for one or more pre-selected jobs, and
a recommendation of courses for enrollment to fill skill gaps for the one or more pre-selected jobs.
